(19) United States
(12) Patent Application Publication
(10) Pub. No.: US 2026/0288091 A1
(43) Pub. Date: Sep. 24, 2026

(54) METHOD AND SYSTEM FOR OPTIMIZATION OF PHYSICAL PARAMETERS FOR SEMICONDUCTOR

(71) Applicant: Samsung Electronics Co., Ltd., Suwon-si (KR)

(72) Inventors: Sungyeop Lee, Suwon-si (KR); Jisu Ryu, Suwon-si (KR); Hiroo Koshimoto, Yokohama (JP); Jaeshin Park, Yokohama (JP); Younggu Kim, Suwon-si (KR)

(21) Appl. No.: 19/572,442

(22) Filed: Mar. 19, 2026

(30) Foreign Application Priority Data
Mar. 20, 2025 (KR) 10-2025-0036219
Jul. 17, 2025 (KR) 10-2025-0097057

(51) Int. Cl. G05B 13/02; H10P 32/00

(52) U.S. Cl. CPC G05B 13/0265; H10P 32/00

(57) ABSTRACT

A method for optimization of physical parameters of physical equations for a semiconductor process includes generating output data that surrogates a solution of the physical equations using an artificial neural network, calculating a total loss function based on a first loss function for the output data and measured data and a second loss function for the output data and the physical equations, training neural network parameters of the artificial neural network and physical parameters of the physical equations based on the total loss function and the artificial neural network, and performing optimization of the physical parameters based on the total loss function in which the neural network parameters are set to have fixed values by the training.

### CROSS-REFERENCE TO RELATED APPLICATION

This application is based on and claims priority under 35 U.S.C. § 119 to Korean Patent Application Nos. 10-2025-0036219, filed on Mar. 20, 2025, and 10-2025-0097057, filed on Jul. 17, 2025, in the Korean Intellectual Property Office, the disclosures of which are incorporated by reference herein in their entireties.

### BACKGROUND

In some examples, design simulators, such as technology computer-aided design (TCAD) simulators, may be used to predict characteristics of semiconductors produced in fields, such as semiconductor manufacturing.

### SUMMARY

To accurately predict characteristics of semiconductors through design simulators, output data representing the characteristics of semiconductors may be observed by varying and entering input data, such as semiconductor layout and ion implantation, into the design simulators, and calibration may be performed to match the output data with target output data.

However, as semiconductor manufacturing processes become more complex, the number of factors to be considered in the simulations increases, making it difficult to perform calibration manually. Deep learning-based calibration may be desired to improve the above, and efforts to enhance the consistency of calibration may be desired.

The present disclosure provides a method and a system for optimization of physical parameters of physical formulas in semiconductor processes.

In some aspects, the present disclosure provides a method for optimization of physical parameters for a semiconductor process involving a dopant diffusion. The method includes: generating, using an artificial neural network, output data that simulates a solution of physical equations related to the dopant diffusion; determining a total loss function based on (i) a first loss function indicative of a difference between the output data and measured data related to dopant concentration resulting from the dopant diffusion and (ii) a second loss function based on the output data and the physical equations; training, based on the total loss function and the artificial neural network, neural network parameters of the artificial neural network and physical parameters of the physical equations; and performing optimization of the physical parameters based on the total loss function, the neural network parameters related to the total loss function being set to fixed values based on the training.

In some aspects, the present disclosure provides a non-transitory computer-readable storage medium for storing instructions that, when executed by a processor, cause the processor to perform an operation for optimization of physical parameters for a semiconductor process involving a dopant diffusion. The operation includes: generating, using an artificial neural network, output data that simulates a solution of physical equations related to the dopant diffusion; determining a total loss function based on (i) a first loss function indicative of a difference between the output data and measured data related to dopant concentration resulting from the dopant diffusion and (ii) a second loss function based on the output data and the physical equations; training, based on the total loss function and the artificial neural network, neural network parameters of the artificial neural network and physical parameters of the physical equations; and performing optimization of the physical parameters based on the total loss function, the neural network parameters related to the total loss function being set to fixed values based on the training.

In some aspects, the present disclosure provides a system including at least one processor, and a storage medium for storing instructions that, when executed by the at least one processor, cause the at least one processor to perform a method for optimization of physical parameters for a semiconductor process involving a dopant diffusion. The method includes: generating, using an artificial neural network, output data that simulates a solution of physical equations related to the dopant diffusion; determining a total loss function based on (i) a first loss function indicative of a difference between the output data and measured data related to dopant concentration resulting from the dopant diffusion and (ii) a second loss function based on the output data and the physical equations; training, based on the total loss function and the artificial neural network, neural network parameters of the artificial neural network and physical parameters of the physical equations; and performing optimization of the physical parameters based on the total loss function, the neural network parameters related to the total loss function being set to fixed values based on the training.

### BRIEF DESCRIPTION OF THE DRAWINGS

FIG. 1 is a block diagram of an example of a system for optimization of physical parameters.

FIG. 2 is a diagram illustrating an example method for optimization of physical parameters.

FIG. 3 is a flowchart illustrating an example method for optimization of physical parameters.

FIG. 4 is a flowchart illustrating an example of operation S32 of FIG. 3;

FIG. 5 is a flowchart illustrating an example of operation S33 of FIG. 3;

FIG. 6 is a flowchart illustrating an example of operation S33 of FIG. 3;

FIG. 7 is a flowchart illustrating an example method for optimization of physical parameters.

FIG. 8 is a diagram of an example of a system for optimization of physical parameters.

FIG. 9 is a block diagram of an example of a computing system including memory for storing a program.

FIG. 10 is a block diagram of an example of a computer system that accesses a storage medium for storing a program.

FIG. 11 is a flowchart illustrating an example method of manufacturing an integrated circuit.

FIG. 12 is a flowchart illustrating an example method of manufacturing the integrated circuit.

### DETAILED DESCRIPTION

Hereinafter, implementations are described in detail with reference to the accompanying drawings.

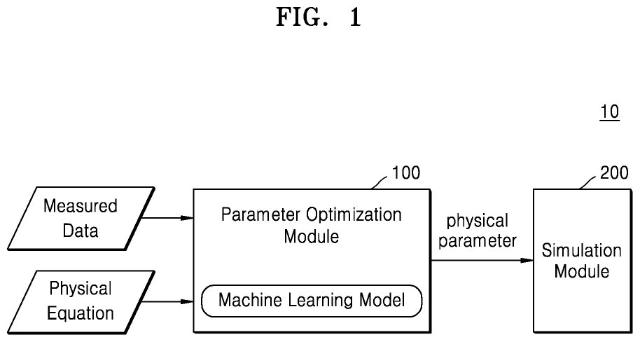

FIG. 1 is a block diagram of a system according to some implementations. Referring to FIG. 1, a system 10 may include a parameter optimization module 100 and a simulation module 200. The parameter optimization module 100 and the simulation module 200 may be implemented in hardware, software, or a combination thereof.

In some implementations, the system 10 may be implemented as a processor-based computing device. For example, the system 10 may include at least one processor and at least one memory storing instructions that, when executed by the processor, cause the processor to perform operations of the parameter optimization module 100 and the simulation module 200.

In some examples, the processor-based computing device may include a server, a workstation, a personal computer, a portable electronic device, a cloud-based computing system, or a combination of computing devices connected through a network.

In some implementations, each of the parameter optimization module 100 and the simulation module 200 may be implemented as software modules executed by one or more processor-based devices. In some implementations, the parameter optimization module 100 and the simulation module 200 may correspond to, or may be implemented on, separate processor-based devices and may communicate with each other through a network.

The parameter optimization module 100 may perform parameter optimization operations, and the simulation module 200 may perform simulation operations. The system 10 may include a system for optimization of physical parameters or a process modeling system that performs simulations for semiconductor design.

The parameter optimization module 100 may receive measured data and physical equations and output optimized physical parameters.

Herein, the measured data may include actual data numerically measured through hardware means, such as sensors and measuring equipment, in a semiconductor process. The measured data may also be referred to as hardware data or experimental data. For example, the measured data may include various information (e.g., time and depth conditions) regarding ion implantation processes, annealing processes, and the like. The measured data may include spatiotemporal coordinates and physical quantities in the corresponding coordinates.

Herein, the physical equations may include one or more equations that describe physical phenomena to be verified through simulations in temporal and spatial domains. The physical equation may include a partial differential equation (PDE) or an ordinary differential equation (ODE) for physical phenomena. For example, the physical equation may include a diffusion equation. The physical equation may include one or more unknown physical parameters. For example, the physical parameters may be related to diffusivity.

The parameter optimization module 100 may optimize learning parameters using a machine learning model. The machine learning model may be referred to as a physics-informed neural network (PINN), but implementations are not limited thereto. The PINN may train the learning parameters based on an artificial neural network and a loss function. The learning parameters may include neural network parameters and physical parameters. The neural network parameters may include weights connecting neurons in the artificial neural network and biases controlling activation thresholds of the neurons. The physical parameters may include specific coefficients included in the physical equations.

The parameter optimization module 100 may optimize the learning parameters based on the artificial neural network and the loss function. The artificial neural network may output data that surrogates or approximates a solution of the physical equations.

The parameter optimization module 100 may train the neural network parameters and the physical parameters based on a first loss function for measured data and output data of the artificial neural network and a second loss function for the output data and the physical equations. The first loss function may include a first term for the measured data and a second term of the output data. Each of the measured data and the output data may be a function for the artificial neural network parameters and the physical parameters. The second loss function may include a first term for the output data and a second term of the physical equations. The physical equations may be a function for the physical parameters. Specifically, the parameter optimization module 100 may calculate a total loss function based on the first loss function and the second loss function. The parameter optimization module 100 may update the neural network parameters and the physical parameters randomly or according to a preset algorithm, until a value of the total loss function reaches a preset range, thereby training the neural network parameters and the physical parameters. The value of the total loss function may reach the preset range by means of the trained neural network parameters and physical parameters.

As a result of the training, additional optimization is required because the trained neural network parameters and physical parameters set the value of the total loss function to a value within the preset range rather than a minimum value of the total loss function. In addition, when the physical parameters and the neural network parameters are trained in a highly complex physical system that requires a plurality of physical equations, the consistency of a small number of physical parameters may be degraded during a training process involving a large number of neural network parameters.

The parameter optimization module 100 may perform optimization (or fine tuning) of physical parameters based on the total loss function in which the neural network parameters are set to trained values and the physical parameters are set to variables. Herein, the total loss function in which the neural network parameters are set to trained values and the physical parameters are set to variables may be referred to as a calibration objective function. For example, the parameter optimization module 100 may obtain physical parameters that minimize a value of the calibration objective function using a gradient descent algorithm. The system 10, according to some implementations, may reduce dependence on a neural network model by performing additional optimization of the physical parameters trained by the artificial neural network and may optimize the physical parameters without manual work by an engineer.

The parameter optimization module 100 may provide the optimized physical parameters to the simulation module 200.

The simulation module 200 may perform simulations based on the physical equations including the optimized physical parameters. The simulations may be performed based on technology computer-aided design (TCAD). Herein, the system 10 is shown to include the simulation module 200 but implementations are not limited thereto. Since output data of the machine learning model included in the parameter optimization module 100 surrogates a solution of the physical equations, the parameter optimization module 100 may operate as a high-speed simulation module or as a physical equation solver itself.

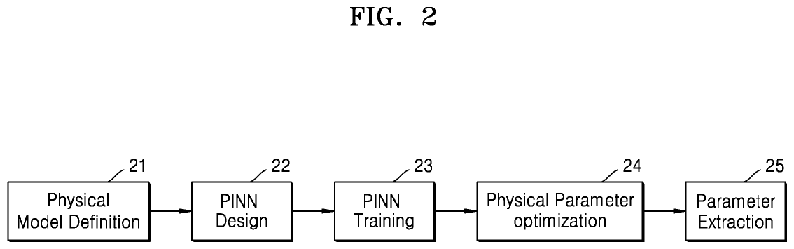

FIG. 2 is a diagram illustrating a method for optimization of physical parameters according to some implementations.

Referring to FIG. 2, the method may include operations of physical model definition 21, PINN design 22, PINN training 23, physical parameter optimization 24, and parameter extraction 25.

In the operation of physical model definition 21, the physical equations, initial conditions, and boundary conditions (or terminal conditions) for the physical phenomena of the system may be mathematically defined, and measured data may be obtained. For example, a diffusion equation for dopant diffusion in a wafer, an initial condition function representing dopant concentration in space at an initial time point, and a boundary condition function representing dopant concentration in space at a terminal time point may be defined, and measured data for dopant concentration in the wafer may be obtained.

In the operation of PINN design 22, an architecture, such as the number of layers of the artificial neural network and the type of activation function, may be determined, and a total loss function may be designed. The total loss function may be designed by performing a weighted sum of the first loss function for the output data of the artificial neural network and the measured data, the second loss function for the output data and the physical equations, a third loss function for the initial conditions, and a fourth loss function for the boundary conditions. The third loss function may represent a difference between the initial condition function and initial condition data of the output data. The fourth loss function may represent a difference between the boundary condition function and boundary condition data of the output data. In the second loss function, the physical parameters may be regarded as learning parameters and may have values that re updated each time the training is repeated.

In the operation of PINN training 23, the neural network parameters and the physical parameters may be trained based on the total loss function, the measured data, and output data of the designed artificial neural network. Specifically, in the operation of PINN training 23, the neural network parameters and the physical parameters may be trained by repeatedly updating the neural network parameters and the physical parameters in a direction that minimizes the value of the total loss function.

In the operation of physical parameter optimization 24, optimization (or fine tuning) of the physical parameters may be performed. Specifically, the physical parameters may be optimized based on the value of the total loss function (i.e., calibration objective function) in which the neural network parameters are set to the values trained in the operation of PINN training 23 and the physical parameters are set to the variables. In some implementations, the physical parameters may be optimized to values that minimize the value of the calibration objective function. In some implementations, the physical parameters may be optimized to a plurality of values that limit the value of the calibration objective function to the preset range. That is, the optimized physical parameters may have a plurality of candidate values, thereby helping to improve design and process margins and optimize process costs.

In the operation of parameter extraction 25, the optimized physical parameters may be extracted to be utilized in simulations relating to physical phenomena or utilized to adjust process variables of sub-processes included in the semiconductor process.

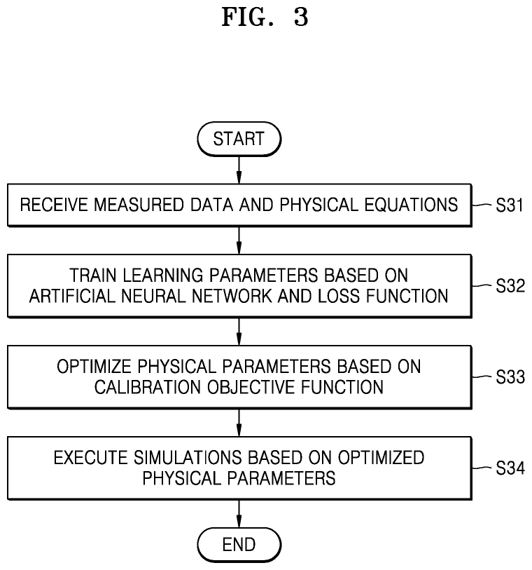

FIG. 3 is a flowchart illustrating a method for optimization of physical parameters, according to some implementations. The method of FIG. 3 may include operations S31 to S34. The method of FIG. 3 may be performed by the system 10 of FIG. 1.

The system 10 may receive the measured data and the physical equations (S31). For example, dopant atoms may chemically interact with point defects, such as interstitials and vacancies, during diffusion. The interstitials may refer to interstitial atoms positioned between lattice sites of the dopant atoms. The vacancies may refer to vacant lattice sites among the lattice sites of the dopant atoms. Thus, the physical equations associated with the dopant diffusion may be defined based on Equation 1 to Equation 3.

$$\frac{\partial {C}_{A}}{\partial t} = - ∇ {J}_{A} \qquad [ Equation 1 ]$$

$$\frac{\partial {C}_{{I}^{total}}}{\partial t} = - ∇ \cdot {J}_{f} - ∇ \cdot {J}_{A} - {R}_{I / V} \qquad [ Equation 2 ]$$

$$\frac{\partial {C}_{{V}^{total}}}{\partial t} = - ∇ \cdot {J}_{V} - ∇ \cdot {J}_{A} - {R}_{I / V} \qquad [ Equation 3 ]$$

Here, C_{A} may denote a concentration of dopants, Cᵢ^{total} may denote a total concentration of interstitials, C_{V}^{total} may denote a total concentration of vacancies, J_{A} may denote a diffusion flux of dopants, J_{I} may denote a diffusion flux of interstitials, J_{V} may denote a diffusion flux of vacancies, and RI/V may denote an interstitial-vacancy recombination rate.

Cᵢ^{total} and Cᵥ^{total} may be defined based on Equation 4.

$${C}_{{X}^{total}} = {C}_{X} + {C}_{AX} ( X = I or V ) \qquad [ Equation 4 ]$$

Here, C_{I} may denote a concentration of interstitials itself, and C_{V} may denote a concentration of vacancies itself, and C_{AX} may denote a concentration of dopant-defect pairs.

The diffusion flux of dopants J_{A} may be defined based on Equation 5.

$${J}_{A} = - {\sum }_{c , X} {{D}_{{AX}^{c}} ( \frac{n}{{n}_{i}} )}^{- c - z} ∇ ( {C}_{A} \frac{{C}_{{X}^{0}}}{{C}_{{X}^{0}}^{*}} {( \frac{n}{{n}_{i}} )}^{z} ) \qquad [ Equation 5 ]$$

Here, n may denote a concentration of electrons, nᵢ may denote a concentration of intrinsic electrons, c may denote a charge state, and Cₓ⁰ may denote a concentration of neutral point defects,

$${C}_{{X}^{0}}^{*}$$

may denote an equilibrium concentration of neutral point defects, z may denote a charge state of dopants, and D_{AXc} may denote a dopant-defect pair diffusivity which is an effective diffusion coefficient. D_{AXc} may be defined based on Equation 6, which is the Arrhenius equation.

$${D}_{{AX}^{c}} = {A}_{{AX}^{c}} exp ( - {E}_{{AX}^{c}} / {k}_{B} T ) \qquad [ Equation 6 ]$$

Here, A_{Axc} may denote a pre-exponential factor, and B_{AXc} may denote an activation energy of the charge state c, and k_{B} may denote a Boltzmann constant, and T may denote a temperature. For example, the physical parameters, θ_{phy} to be optimized may denote A_{AXc} However, the present disclosure is not limited thereto, and various factors included in the physical equations may be adopted as physical parameters to be optimized.

The diffusion flux of defects Jₓ may be defined based on Equation 7.

$${J}_{X} = - {D}_{X} {C}_{X}^{*} ∇ ( \frac{{C}_{X}}{{C}_{X}^{*}} ) ( X = I or V ) \qquad [ Equation 7 ]$$

Here, D_{X} may denote a defect diffusivity, and

$${C}_{X}^{*}$$

may denote an equilibrium concentration of defects.

The system 10 may train the learning parameters based on the artificial neural network and the loss function (S32). The learning parameters may include the physical parameters θ_{phy} and the neural network parameters θ_{NN} of the artificial neural network. The artificial neural network may have input data (x, t) and output data u_{θNN}(x,t), wherein x ∈Ω, t ∈ [0, T].

The system 10 may calculate a total loss function L(θ_{NN}, θ_{phy}) based on Equation 8.

$$L ( {θ}_{NN} , {θ}_{phy} ) = {λ}_{r} {L}_{r} ( {θ}_{NN} , {θ}_{phy} ) + {λ}_{0} {L}_{0} ( {θ}_{NN} ) + {λ}_{b} {L}_{b} ( {θ}_{NN} ) + {λ}_{d} {L}_{d} ( {θ}_{NN} ) \qquad [ Equation 8 ]$$

Here, λᵣ, λ₀, λ_{b}, λ_{d} may each denote a parameter that controls a weight of each term, and Lᵣ may denote a loss function for the physical equations, L₀ may denote a loss function for the initial conditions, L_{b} may denote a loss function for the boundary conditions, and L_{d} may denote a loss function for the measured data. Herein, Lᵣ may be referred to as the second loss function, L₀ may be referred to as the third loss function, L_{b} may be referred to as the fourth loss function, and L_{d} may be referred to as the first loss function.

The system 10 may calculate the loss function Lᵣ for the physical equations based on Equation 9.

$${L}_{r} ( {θ}_{NN} , {θ}_{phy} ) = \frac{1}{{N}_{r}} {\sum }_{i = 1}^{{N}_{r}} {\vert N [ {u}_{{θ}_{NN}} ] ( {x}_{r}^{i} , {t}_{r}^{i} ; {θ}_{NN} , {θ}_{phy} ) - f ( {x}_{r}^{i} , {t}_{r}^{i} , {θ}_{phy} ) \vert}^{2} \qquad [ Equation 9 ]$$

Here, Nᵣ may denote the number of collocation points

$${x}_{r}^{i} , {t}_{r}^{i} ,$$

and N[u_{θNN}] may denote a value obtained by applying a differential operator N to the output data u_{θNN}, and f may denote a source term of the governing equation. For example, N[U_{θNN}] may surrogate a left-hand side term

$$\frac{\partial {C}_{A}}{\partial t}$$

of Equation 1, and f may correspond to a right-hand side term −∇·J_{A} of Equation 1. That is, Lᵣ may denote a difference between the physical equation and a surrogate function that surrogates

$$\frac{\partial {C}_{A}}{\partial t}$$

based on output data U_{θNN}(x,t) of the artificial neural network. N[u_{θNN}]−ƒ may be referred to as residuals of the physical equations, and the loss function Lᵣ may be calculated through the mean squared residuals of the physical equations calculated at the collocation points.

The system 10 may calculate the loss function L₀ for the initial conditions based on Equation 10.

$${L}_{0} ( {θ}_{NN} ) = \frac{1}{{N}_{0}} {\sum }_{i = 1}^{{N}_{0}} {\vert {u}_{{θ}_{NN}} ( {x}_{0}^{i} , 0 ; {θ}_{NN} ) - {u}_{0} ( {x}_{0}^{i} , {t}_{r}^{i} ) \vert}^{2} \qquad [ Equation 10 ]$$

Here, N₀ may denote the number of collocation points

$$( {x}_{0}^{i} , 0 ) ,$$

and u₀ may denote an initial condition function defined when defining a physical model, similar to the physical equations. u₀ may be independent of the physical parameters θ_{phy}. That is, L₀ may denote a difference between initial condition data calculated based on the output data u_{θNN} (x,t) and the initial condition function. U_{θNN}−u₀ may be referred to as the residual of the initial conditions, and the loss function L₀ may be calculated through the mean squared residuals of the initial conditions calculated at the collocation points.

The system 10 may calculate the loss function L_{b} for the boundary conditions based on Equation 11.

$${L}_{b} ( {θ}_{NN} ) = \frac{1}{{N}_{b}} {\sum }_{i = 1}^{{N}_{b}} {\vert B [ {u}_{{θ}_{NN}} ] ( {x}_{b}^{i} , {t}_{b}^{i} ; {θ}_{NN} ) - g ( {x}_{b}^{i} , {t}_{b}^{i} ) \vert}^{2} \qquad [ Equation 11 ]$$

Here, Nb may denote the number of collocation points

$$( {x}_{b}^{i} , {t}_{b}^{i} ) ,$$

may denote a value obtained by applying a boundary operator B to the output data u_{θNN}, and g may denote a boundary condition function defined when defining the physical model, similar to the physical equations. For example, the boundary operator B may include a Dirichlet boundary condition operator, a Neumann boundary condition operator, or a Robin boundary condition operator. g may be independent of the physical parameters θ_{phy} That is, L_{b} may denote a difference between the boundary condition data calculated based on B[u_{θNN}] and the boundary condition function. B[u_{θNN}]−g may be referred to as the residual of the boundary conditions, and the loss function L_{b} may be calculated through the mean squared residuals of the boundary conditions calculated at the collocation points.

The system 10 may calculate the loss function L_{d} for the measured data based on Equation 12.

$${L}_{d} ( {θ}_{NN} ) = \frac{1}{{N}_{d}} {\sum }_{i = 1}^{{N}_{d}} {\vert {u}_{{θ}_{NN}} ( {x}_{d}^{i} , {t}_{d}^{i} ; {θ}_{NN} ) - {u}_{d} ( {x}_{d}^{i} , {t}_{d}^{i} ) \vert}^{2} \qquad [ Equation 12 ]$$

Here, N_{d} may denote the number of collocation points

$$( {x}_{d}^{i} , {t}_{d}^{i} ) , and {u}_{d} ( {x}_{d}^{i} , {t}_{d}^{i} )$$

include the measured data of the collocation points. That is, L_{d} may denote a difference between the measured data and the output data u_{θNN}(x, t) of the artificial neural network. U_{θNN}−u_{d} may be referred to as a residual of the data, and the loss function L_{d} may be calculated through the mean squared residuals of the data calculated at the collocation points.

The system 10 may repeat the training process, where the neural network parameters θ_{NN} are updated to obtain the output data u_{θNN}(x,t) and the physical parameters θ_{phy} are updated to calculate the minimum value of the total loss function, until the minimum value of the total loss function L(θ_{NN}, θ_{phy}) reaches the preset range. In each training process, the neural network parameters θ_{NN} and the physical parameters θ_{phy} may be updated randomly or according to a preset algorithm. For example, the physical parameters θ_{phy} may be updated based on the gradient descent algorithm. The neural network parameters trained in operation S32 may be expressed as

$${θ}_{NN}^{*}$$

The system 10 may optimize the physical parameters θ_{phy} based on the calibration objective function (S33). The calibration objective function may include the total loss function

$$L ( {θ}_{NN}^{*} , {θ}_{phy} )$$

where the neural network parameters are set to

$${θ}_{NN}^{*} .$$

The calibration objective function may be used to calculate the optimized physical parameters θ_{phy} that minimize the total loss function by setting the physical parameters

$${θ}_{phy}^{*}$$

as variables. In some implementations, the optimized physical parameters

$${θ}_{phy}^{*}$$

having multiple values limiting the value of the total loss function to a reference range may be obtained.

According to some implementations, by using the calibration objective function dedicated to optimization of physical parameters, the physical parameters may be optimized according to clear and consistent criteria. In addition, multiple physical parameter candidates with optimized values may be calculated without repetitive training process through the artificial neural network, helping to improve design and process margins and optimize process costs.

The system 10 may execute simulations based on the optimized physical parameters

$${θ}_{phy}^{*}$$

(S34). Specifically, the system 10 may perform simulations based on the physical equations including the optimized physical parameters

$${θ}_{phy}^{*} .$$

In some implementations, in operation S34, the system 10 may adjust process condition parameters based on the simulation data. In addition, the system 10 may perform sub-processes included in the semiconductor process based on the adjusted process condition parameters. The process condition parameters may refer to a parameter set for operating conditions and sequences of process equipment required to perform sub-processes (e.g., deposition, etching, diffusion, and annealing). For example, the process condition parameters may include a process time, a temperature, a pressure, and an amount of dopant implantation, but implementations are not limited thereto.

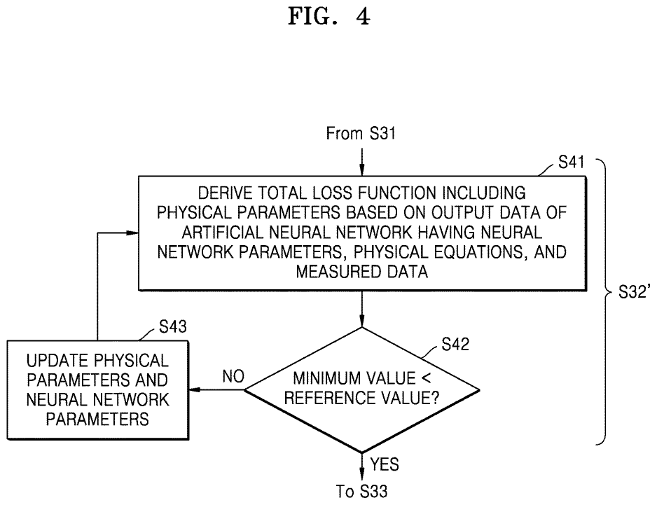

FIG. 4 is a flowchart illustrating an example of operation S32 of FIG. 3.

Operation S32′ may include some implementations of operation S32 of FIG. 3. Operation S32′ may include a plurality of operations S41, S42, and S43.

The system 10 may calculate the total loss function L including the physical parameters θ_{phy}, based on the output data u_{θNN} of the artificial neural network having the neural network parameters θ_{NN}, the physical equations, and the measured data u_{d} (S41).

The system 10 may compare the total loss function L with a reference value (S42). When the minimum value of the total loss function L is the reference value or more (S42=N), the system 10 may update the neural network parameter θ_{NN} and the physical parameter θ_{phy} (S43). For example, the system 10 may adjust the neural network parameters θ_{NN} and the physical parameters θ_{phy} randomly or according to a preset algorithm.

The system 10 may perform operation S41 based on the updated neural network parameters θ_{NN} and physical parameters θ_{phy}.

The system 10 may repeatedly perform operations S41 and S43 until the minimum value of the total loss function L is less than the reference value (S42=Y). As operations S41, S42, and S43 are performed repeatedly, the neural network parameters θ_{NN} and the physical parameters θ_{phy} may be trained.

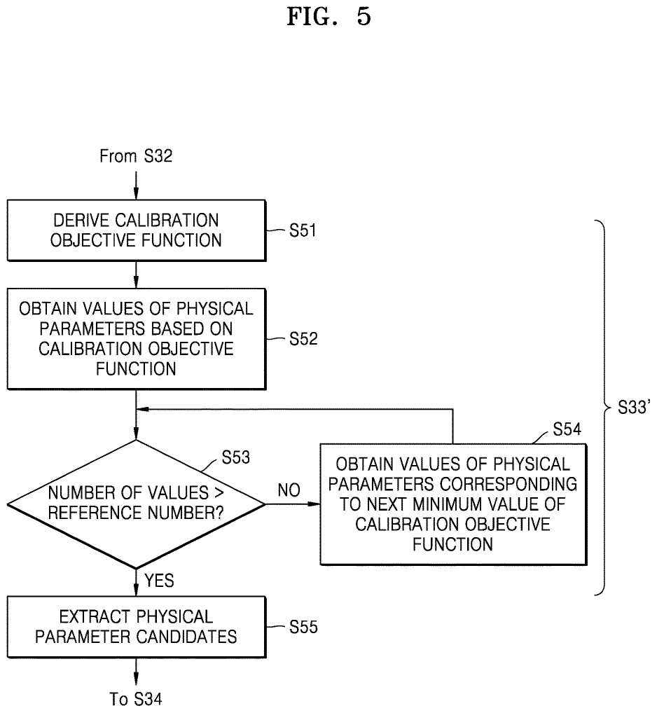

FIG. 5 is a flowchart illustrating an example of operation S33 of FIG. 3.

Operation S33′ may include some implementations of operation S33 in FIG. 3. Operation S33′ may include a plurality of operations S51, S52, S53, S54, and S55.

The system 10 may calculate the calibration objective function L_{calib} based on the total loss function L and the neural network parameters

$${θ}_{NN}^{*}$$

trained and having fixed values (S51). Specifically, the system 10 may calculate the calibration objective function L_{calib} based on Equation 13.

$${L}_{calib} ( {θ}_{phy} ) = L ( {θ}_{phy} \vert {θ}_{NN}^{*} ) = {λ}_{r} {L}_{r} ( {θ}_{phy} \vert {θ}_{NN}^{*} ) + C \qquad [ Equation 13 ]$$

Here, C may denote a constant having the same value as

$${λ}_{0} {L}_{0} ( {θ}_{NN}^{*} ) + {λ}_{b} {L}_{b} ( {θ}_{NN}^{*} ) + {λ}_{d} {L}_{d} ( {θ}_{NN}^{*} )$$

The system 10 may obtain values of the optimized physical parameters

$${θ}_{phy}^{*}$$

based on the calibration objective function L_{calib} (S52). Specifically, the system 10 may calculate the optimized physical parameters

$${θ}_{phy}^{*}$$

based on Equation 14.

$${θ}_{phy}^{*} = arg min {L}_{calib} ( {θ}_{phy} ) \qquad [ Equation 14 ]$$

Here, argmin may denote a function that returns the values of the physical parameters θ_{phy} that minimize the calibration objective function L_{calib}.

Generally, the physical parameters θ_{phy} may have linear characteristics within the physical equations. As the loss function Lᵣ is calculated using a mean squared error method for the physical equations in Equation 9, the calibration objective function L_{calib} may include a quadratic function for the physical parameters θ_{phy}.

$${L}_{calib} ( {θ}_{phy} ) = {{λ}_{r} ( {ω}^{T} {θ}_{phy} + {ω}_{0} )}^{2} + C \qquad [ Equation 15 ]$$

Here, ω and ω₀ may denote constants.

Since the calibration objective function L_{calib} is a convex function for the physical parameters θ_{phy}, an optimal solution may be obtained. For convenience of explanation, the calibration objective function L_{calib} is described as a two-dimensional function, but implementations are not limited thereto.

In some implementations, when the physical model is defined using a plurality of physical equations, the calibration objective function L_{calib} may be calculated based on the sum of residuals of each physical equation. The calibration objective function L_{calib} may include a multi-dimensional function having convexity with respect to the physical parameters θ_{phy} That is, there may exist physical parameters L_{calib} for which a first derivative of the calibration objective function L_{calib} is zero. Therefore, there may exist a global minimum value for the calibration objective function L_{calib}.

When the number of values of the calculated physical parameters θ_{phy} is the reference number or less (S53=N), the system 10 may obtain the values of the physical parameters θ_{phy} corresponding to the next minimum value (S54). However, the present disclosure is not limited thereto. The system 10 may obtain the values of the physical parameters θ_{phy} near the global minimum value of the calibration objective function L_{calib}. while operations S52 and S54 are repeated, the number of values of the physical parameters θ_{phy} may be counted, and the values of the calculated physical parameters θ_{phy} may be stored cumulatively.

When the number of values of the calculated physical parameters θ_{phy} is greater than the reference number (S53=Y), the system 10 may extract the values of the calculated physical parameters θ_{phy} as optimal physical parameter candidates (S65).

According to some implementations, by extracting a plurality of candidate values as values of the optimized physical parameters, the range of selectable process variables may be broadened, thereby improving design and process margins.

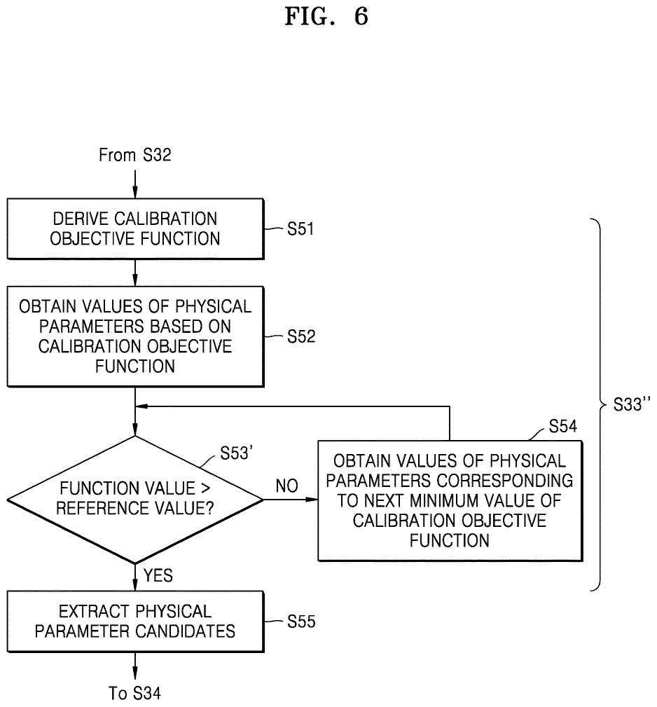

FIG. 6 is a flowchart illustrating an example of operation S33 of FIG. 3.

Operation S33″ may include some implementations of operation S33 of FIG. 3. Operation S33″ may include operation S53′, unlike operation S33′ of FIG. 5. The descriptions that are substantially the same as those given with reference to FIG. 5 may be omitted.

When a function value of the calibration objective function corresponding to the calculated physical parameters θ_{phy} is the reference value or less (S53′=N), the system 10 may obtain the values of the physical parameters θ_{phy} corresponding to the next minimum value of the calibration objective function L_{calib} (S54). However, the present disclosure is not limited thereto. The system 10 may obtain the values of the physical parameters θ_{phy} corresponding to one of values near the global minimum value of the calibration objective function L_{calib} The function value of the calibration objective function may be monitored while operations S52 and S54 are repeated, and the values of the calculated physical parameters θ_{phy} may be stored cumulatively.

When the function value of the calibration objective function is greater than the reference value (S53=Y), the system 10 may obtain the values of the physical parameters θ_{phy} as optimal physical parameter candidates (S65).

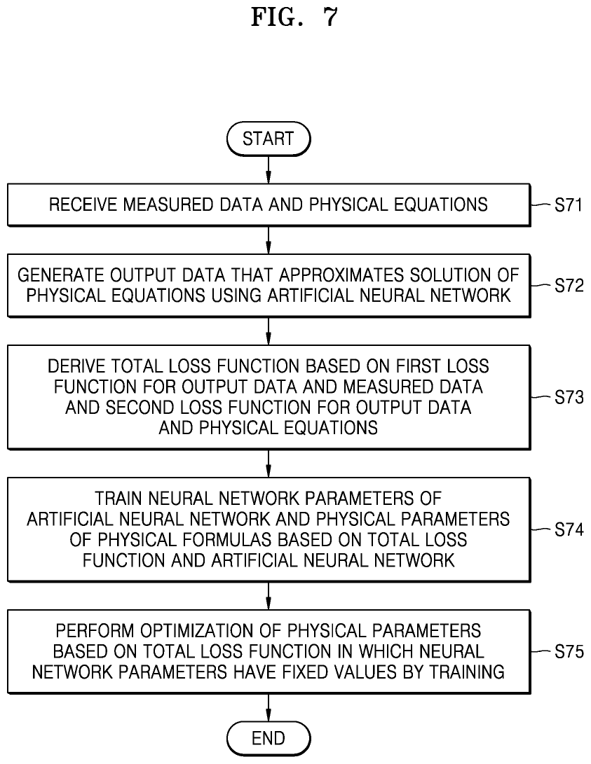

FIG. 7 is a flowchart illustrating a method for optimization of physical parameters according to some implementations. Referring to FIG. 7, the method for optimization of physical parameters may include a plurality of operations S71 to S75. The method for optimization of physical parameters may be performed by the system 10 of FIG. 1.

The method may include receiving physical formulas and measured data (S71). Herein, the physical formulas may include physical equations, formulas for the initial conditions, and formulas for the boundary conditions. For example, the physical formulas may include fin Equation 9, u₀ in Equation 10, and g in Equation 11. The physical formulas may also be referred to as physical constraints.

The method may include generating output data that surrogates a solution of the physical formulas using the artificial neural network (S72).

The method may include deriving the total loss function based on the first loss function for the output data and the measured data and the second loss function for the output data and the physical formulas (S73).

The method may include training the neural network parameters of the artificial neural network and the physical parameters of the physical formulas based on the total loss function and the artificial neural network (S74).

The method may include performing optimization of the physical parameters based on the total loss function in which the neural network parameters are set to have fixed values by the training (S75).

Operation S71 may be included in operation S31 of FIG. 3, operations S72 to S75 may be included in operation S32 of FIG. 3, and operation S75 may be included in operation S33 of FIG. 3.

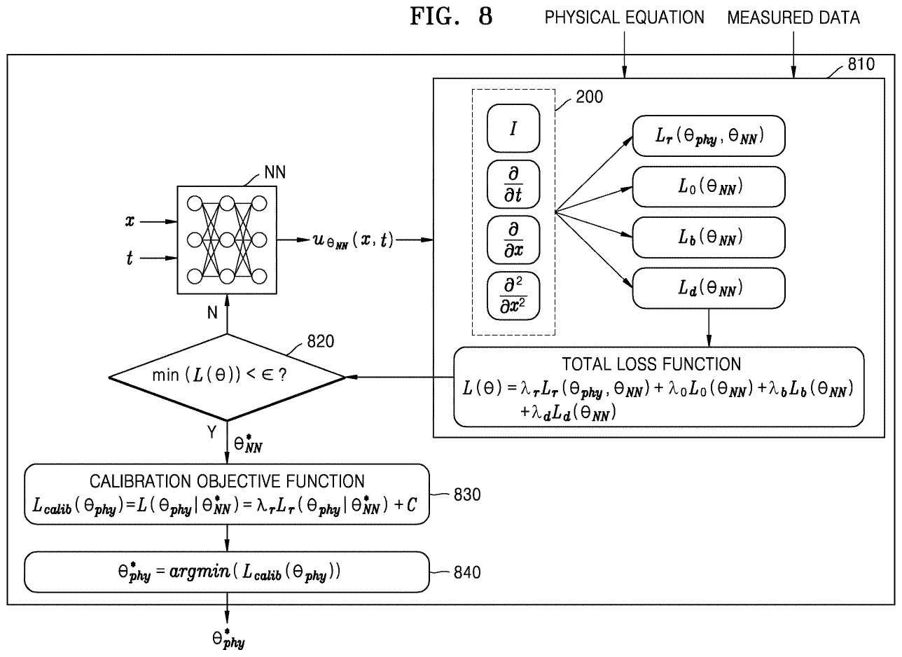

FIG. 8 is a diagram of a system for optimization of physical parameters, according to some implementations. The system 800 of FIG. 8 may perform each operation of the method for optimization of physical parameters.

The system 800 may receive physical formulas and measured data. The physical formulas may include physical equations, initial condition functions, and boundary condition functions.

The system 800 may include an artificial neural network NN that generates the output data u_{θNN} (x, t) that surrogates a solution of the physical formulas for the input data (x, t).

The system 800 may calculate the total loss function L(θ) based on the output data u_{θNN} (x, t), the physical formulas, and measured data. Specifically, the system 800 may calculate the loss function Lᵣ for the physical equations based on Equation 9, and the loss function L₀ for the initial conditions based on Equation 10, and the loss function L_{b} for the boundary conditions based on Equation 11, and the loss function L_{d} for the measured data based on Equation 12. In addition, the system 800 may calculate the total loss function L(θ) based on Equation 8. θ may include the neural network parameters θ_{NN} and the physical parameters θ_{phy} as learning parameters.

The system 800 may calculate the learning parameters θ that minimize the total loss function L(θ) For example, the system 800 may calculate the learning parameters θ based on the gradient descent algorithm.

When the minimum value of the total loss function L(θ) is not included in the reference range ∈ (820=N), the system 800 may update the learning parameters to generate the output data u_{θNN} (x,t) and the total loss function L(θ) based on the updated learning parameters and determine whether the minimum value of the total loss function L(θ) is within the reference range ∈.

When the minimum value of the total loss function L(θ) is included in the reference range ∈ (820=N), the system 800 may calculate the calibration objective function L_{calib}(θ_{phy}) based on the trained neural network parameters

$${θ}_{NN}^{*}$$

and the total loss function L(θ). Specifically, the system 800 may calculate, as the calibration objective function L_{calib}(θ_{phy}), the total loss function

$$L ( {θ}_{phy} \vert {θ}_{NN}^{*} )$$

in which the neural network parameters are set to have trained values. That is, referring to Equation 13, the calibration objective function L_{calib}(θ_{phy}) is identical to

$${λ}_{r} {L}_{r} ( {θ}_{phy} \vert {θ}_{NN}^{*} ) + C ,$$

where C may denote a constant corresponding to

$${λ}_{0} {L}_{0} ( {θ}_{NN}^{*} ) + {λ}_{b} {L}_{b} ( {θ}_{NN}^{*} ) + {λ}_{d} {L}_{d} ( {θ}_{NN}^{*} ) .$$

The system 800 may calculate the physical parameters θ_{phy} that minimize the calibration objective function L_{calib} as optimized physical parameters

$${θ}_{phy}^{*} .$$

The system 800 may output the optimized physical parameters

$${θ}_{phy}^{*} .$$

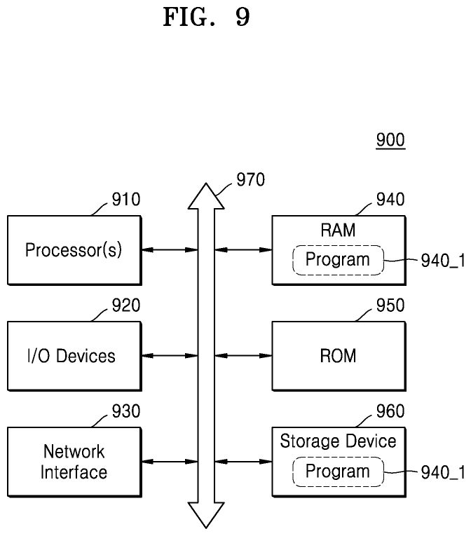

FIG. 9 is a block diagram of a computing system including memory for storing a program according to some implementations. At least a portion of the method for optimization of physical parameters may be performed by a computing system 900. In some implementations, the computing system 900 may be referred to as a system for optimization of physical parameters. The computing system 900 may include the system 10 of FIG. 1.

The computing system 900 may include a fixed computing system, such as a desktop computer, a workstation, or a server, or may include a portable computing system, such as a laptop computer. As shown in FIG. 9, the computing system 900 may include a processor 910, input/output (I/O) devices 920, a network interface 930, random-access memory (RAM) 940, read-only memory (ROM) 950, and a storage device 960. The processor 910, the I/O devices 920, the network interface 930, the RAM 940, the ROM 950, and the storage device 960 may be connected to a bus 970 and may communicate with each other through the bus 970.

The processor 910 may be referred to as a processing unit and may include at least one core capable of executing any instruction set (e.g., Intel Architecture-32 (IA-32), 64-bit extended IA-32, x86-64, PowerPC, Sparc, MIPS, ARM, and IA-64), such as a microprocessor, an application processor (AP), a digital signal processor (DSP), or a graphics processing unit (GPU). For example, the processor 910 may access memory, i.e., the RAM 940 or the ROM 950, through the bus 970, and may execute instructions stored in the RAM 940 or the ROM 950.

The RAM 940 may store a program 940_1, or at least a portion thereof, for performing the method for optimization of physical parameters of the physical formulas, and the program 940_1 may cause the processor 910 to perform at least some of the operations included in the method for optimization of physical parameters. That is, the program 940_1 may include a plurality of instructions executable by the processor 910, and the plurality of instructions included in the program 940_1 may cause the processor 910 to perform at least some of the operations included in the aforementioned method.

The storage device 960 may retain stored data even when power supplied to the computing system 900 is interrupted. For example, the storage device 960 may include a non-volatile memory device and may include a storage medium, such as magnetic tape, optical disc, and magnetic disk. In addition, the storage device 960 may be detachable from the computing system 900. The storage device 960 may store the program 940_1 according to some implementations, and the program 940_1 or at least a portion thereof may be loaded from the storage device 960 into the RAM 940 before the program 940_1 is executed by the processor 910. Alternatively, the storage device 960 may store a file written in a programming language, and the program 940_1 or at least a portion thereof generated from the file by a compiler or the like may be loaded into the RAM 940. In some implementations, the RAM 940 and the storage device 960 may further store simulation programs that are executed based on the optimized physical parameters. In some implementations, the RAM 940 and the storage device 960 may store process condition parameters for each of sub-processes of the semiconductor process.

The storage device 960 may also store data to be processed by the processor 910 or data processed by the processor 910.

The I/O devices 920 may include input devices, such as a keyboard and a pointing device, and may include output devices, such as a display device and a printer. For example, the I/O devices 920 may receive, from a user, signals, physical formulas, or measured data, that trigger execution of the program 940_1 by the processor 910, and may provide the optimized physical parameters, the trained neural network parameters, and the simulation data.

The network interface 930 may provide access to a network external to the computing system 900. For example, the network may include a plurality of computing systems and communication links, wherein the communication links may include wired links, optical links, wireless links, or any other type of links.

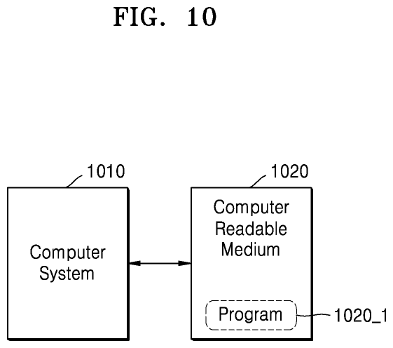

FIG. 10 is a block diagram of a computer system that accesses a storage medium for storing a program, according to some implementations. At least some of the operations included in the method for optimization of physical parameters of physical formulas may be performed by a computer system 1010. The computer system 1010 may access a computer-readable medium 1020 and may execute a program 1020_1 stored in the computer-readable medium 1020. In some implementations, the computer system 1010 and the computer-readable medium 1020 may be collectively referred to as a system for optimization of physical parameters of physical formulas.

The computer system 1010 may include at least one computer subsystem, and the program 1020_1 may include at least one component executed by the at least one computer subsystem. For example, the at least one component may include a machine learning model, a parameter optimization module, or a simulation module described above with reference to the drawings. The computer-readable medium 1020 may include a non-volatile memory device, similar to the storage device 960 of FIG. 9, and may include a storage medium, such as magnetic tape, optical disc, and magnetic disk. Additionally, the computer-readable medium 1020 may be removable from the computer system 1010.

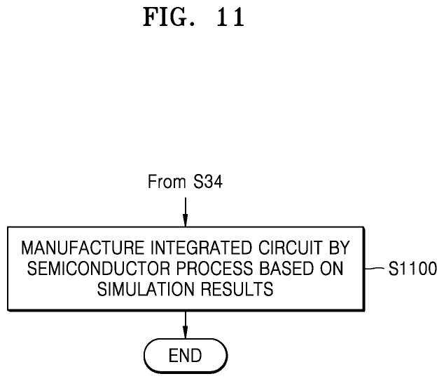

FIG. 11 is a flowchart illustrating a method of manufacturing an integrated circuit according to some implementations. Operation S1100 of FIG. 11 may be performed after operation S34 of FIG. 3.

In operation S1100, the method may obtain simulation results based on the optimized physical parameters and manufacture an integrated circuit by the semiconductor process based on the simulation results. For example, the integrated circuit may be manufactured by the semiconductor process to which the process condition parameters that are finally adjusted in operation S34 are applied. The semiconductor process may include a front-end-of-line (FEOL) process and a back-end-of-line (BEOL) process using masks fabricated based on the integrated circuit. For example, the FEOL may include planarizing and cleaning a wafer, forming trenches, forming wells, forming gate lines, forming sources and drains, and the like. In addition, the BEOL may include silicidating gate, source, and drain regions, adding a dielectric, planarizing, forming holes, adding metal layers, forming vias, forming passivation layers, and the like.

Through simulations performed based on the optimized physical parameters through the calibration objective function, consistency may be improved and accuracy of simulation results for characteristics of the integrated circuit may be enhanced. The integrated circuit manufactured in operation S1100 may have high consistency with the simulation results of operation S34. Accordingly, the time and cost for manufacturing the integrated circuit having good characteristics may be reduced, and the integrated circuit having better characteristics may be manufactured.

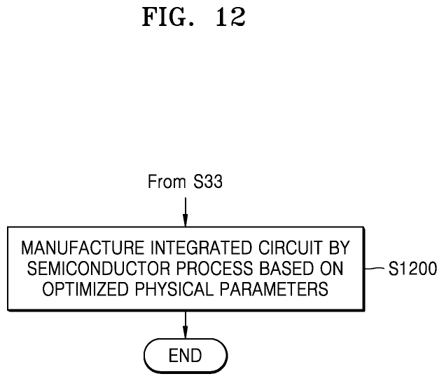

FIG. 12 is a flowchart illustrating the method of manufacturing the integrated circuit, according to some implementations. Operation S1200 of FIG. 12 may be performed after operation S33 of FIG. 3.

In operation S1200, the method may adjust the process condition parameters of the semiconductor process based on the optimized physical parameters and manufacture the integrated circuit through the semiconductor process to which the adjusted process condition parameters are applied.

In some implementations, the calculating of the total loss function may include calculating the total loss function by performing a weighted sum of the first loss function, the second loss function, the third loss function for initial conditions, and the fourth loss function for boundary conditions.

In some implementations, the total loss function in which the neural network parameters are set to have fixed values may have convexity with respect to the physical parameters.

While the disclosure has been particularly shown and described with reference to implementations thereof, it will be understood that various changes in form and details may be made therein without departing from the spirit and scope of the following claims.

What is claimed is:

1. A method for optimization of physical parameters for a semiconductor process involving a dopant diffusion, the method comprising:
generating, using an artificial neural network, output data that simulates a solution of physical equations related to the dopant diffusion;
determining a total loss function based on (i) a first loss function indicative of a difference between the output data and measured data related to dopant concentration resulting from the dopant diffusion and (ii) a second loss function based on the output data and the physical equations;
training, based on the total loss function and the artificial neural network, neural network parameters of the artificial neural network and physical parameters of the physical equations; and
performing optimization of the physical parameters based on the total loss function, the neural network parameters related to the total loss function being set to fixed values based on the training.

2. The method of claim 1, wherein performing of the optimization of the physical parameters comprises obtaining the physical parameters that minimize the value of the total loss function.

3. The method of claim 1, wherein performing of the optimization of the physical parameters comprises obtaining the physical parameters having a plurality of values that limit a value of the total loss function within, or equal to, a reference range.

4. The method of claim 1, wherein determining the total loss function comprises calculating the total loss function based on performing a weighted sum of (i) the first loss function, (ii) the second loss function, (iii) a third loss function based on initial conditions, and (iv) a fourth loss function based on boundary conditions.

5. The method of claim 4, wherein the total loss function corresponds to a sum of (i) a constant and (ii) the second loss function, and
wherein the neural network parameters related to the second loss function are set to fixed values based on the training.

6. The method of claim 1, wherein the total loss function has convexity with respect to the physical parameters.

7. The method of claim 1, wherein the physical equations comprise partial differential equations for diffusion of dopants, and the physical parameters are related to diffusivity of the partial differential equations.

8. The method of claim 1, wherein values of the physical parameters determined based on the training are different from values of the physical parameters determined based on the optimization.

9. The method of claim 1, comprising:
generating simulation data based on the physical parameters;
adjusting at least a portion of the semiconductor process based on the simulation data; and
manufacturing an integrated circuit based on the adjusted portion of the semiconductor process.

10. A non-transitory computer-readable storage medium for storing instructions that, when executed by a processor, cause the processor to perform an operation for optimization of physical parameters for a semiconductor process involving a dopant diffusion, the operation comprising:
generating, using an artificial neural network, output data that simulates a solution of physical equations related to the dopant diffusion;
determining a total loss function based on (i) a first loss function indicative of a difference between the output data and measured data related to dopant concentration resulting from the dopant diffusion and (ii) a second loss function based on the output data and the physical equations;
training, based on the total loss function and the artificial neural network, neural network parameters of the artificial neural network and physical parameters of the physical equations; and
performing optimization of the physical parameters based on the total loss function, the neural network parameters related to the total loss function being set to fixed values based on the training.

11. The non-transitory computer-readable storage medium of claim 10, wherein
performing of the optimization of the physical parameters comprises obtaining the physical parameters that minimize the value of the total loss function.

12. The non-transitory computer-readable storage medium of claim 10, wherein
performing of the optimization of the physical parameters comprises obtaining the physical parameters having a plurality of values that limit a value of the total loss function within, or equal to, a reference range.

13. The non-transitory computer-readable storage medium of claim 10, wherein
determining the total loss function comprises calculating the total loss function based on performing a weighted sum of (i) the first loss function, (ii) the second loss function, (iii) a third loss function based on initial conditions, and (iv) a fourth loss function based on boundary conditions.

14. The non-transitory computer-readable storage medium of claim 10, wherein the total loss function corresponds to a sum of (i) a constant and (ii) the second loss function, and
wherein the neural network parameters related to the second loss function are set to fixed values based on the training.

15. The non-transitory computer-readable storage medium of claim 10, wherein the total loss function has convexity with respect to the physical parameters.

16. The non-transitory computer-readable storage medium of claim 10, wherein the physical equations comprise partial differential equations for diffusion of dopants, and the physical parameters are related to diffusivity of the partial differential equations.

17. The non-transitory computer-readable storage medium of claim 10, wherein
values of the physical parameters determined based on the training are different from values of the physical parameters determined based on the optimization.

18. A system comprising:
at least one processor; and
a storage medium for storing instructions that, when executed by the at least one processor, cause the at least one processor to perform a method for optimization of physical parameters for a semiconductor process involving a dopant diffusion,
wherein the method comprises:
generating, using an artificial neural network, output data that simulates a solution of physical equations related to the dopant diffusion;
determining a total loss function based on (i) a first loss function indicative of a difference between the output data and measured data related to dopant concentration resulting from the dopant diffusion and (ii) a second loss function based on the output data and the physical equations;
training, based on the total loss function and the artificial neural network, neural network parameters of the artificial neural network and physical parameters of the physical equations; and
performing optimization of the physical parameters based on the total loss function, the neural network parameters related to the total loss function being set to fixed values based on the training.

19. The system of claim 18, wherein performing of the optimization of the physical parameters comprises obtaining the physical parameters that minimize the value of the total loss function.

20. The system of claim 18, wherein performing of the optimization of the physical parameters comprises obtaining the physical parameters having a plurality of values that limit a value of the total loss function within, or equal to, a reference range.
